(19) United States
(12) Patent Application Publication
(10) Pub. No.: US 2019/0207889 A1
(43) Pub. Date: Jul. 4, 2019

(54) FILTERING GRAPHIC CONTENT IN A MESSAGE TO DETERMINE WHETHER TO RENDER THE GRAPHIC CONTENT OR A DESCRIPTIVE CLASSIFICATION OF THE GRAPHIC CONTENT

(71) Applicant: International Business Machines Corporation, Armonk, NY (US)

(72) Inventors: Lisa S. DeLuca, San Francisco, CA (US); Jeremy A. Greenberger, San Jose, CA (US)

(21) Appl. No.: 15/861,529

(22) Filed: Jan. 3, 2018

(51) Int. Cl. H04L 12/58; G06Q 10/10; G06K 9/62; G06F 17/27

(52) U.S. Cl. CPC H04L 51/12; H04L 51/10; G06F 17/27; G06K 9/6267; G06Q 10/1093

(57) ABSTRACT

Provided are a computer program product, system, and method for filtering graphic content in a message to determine whether to render the graphic content or a descriptive classifier of the graphic content. An incoming message is processed for the messaging application including a graphic object having graphic content. An image classifier application processes the graphic content to determine a descriptive classifier of the graphic content in response to determining that filtering is enabled. Rendering is caused of the descriptive classifier in a user interface without rendering the graphic content in response to the filtering being enabled. Rendering is caused of the graphic content in the user interface in response filtering not being enabled.

### BACKGROUND OF THE INVENTION

### 1. Field of the Invention

The present invention relates to a computer program product, system, and method for filtering graphic content in a message to determine whether to render the graphic content or a descriptive classifier of the graphic content.

### 2. Description of the Related Art

Computer users may receive messages from friends through emails or a messaging application with amusing graphic content, such as a Graphic Interchange Format (GIF) file. The rendering of such graphic content may distract the user and be shown on a large area of the user display screen so as to distract the user or be viewed by others nearby, which the user of the computing device may not desire, especially if the rendered graphic content is inappropriate for the environment.

There is a need in the art for developing improved techniques for rendering graphic content in received messages at a computing device.

### SUMMARY

Provided are a computer program product, system, and method for filtering graphic content in a message to determine whether to render the graphic content or a descriptive classifier of the graphic content. An incoming message is processed for the messaging application including a graphic object having graphic content. An image classifier application processes the graphic content to determine a descriptive classifier of the graphic content in response to determining that filtering is enabled. Rendering is caused of the descriptive classifier in a user interface without rendering the graphic content in response to the filtering being enabled. Rendering is caused of the graphic content in the user interface in response filtering not being enabled.

### BRIEF DESCRIPTION OF THE DRAWINGS

FIG. 1 illustrates an embodiment of a computing device.

FIG. 2 illustrates an embodiment of an image classification rule.

FIG. 3 illustrates an embodiment of a context attribute rule.

FIG. 4 illustrates an embodiment of operations to apply image classification and context attribute rules to filter graphic content.

FIG. 5 illustrates an embodiment of operations to process an image classification rule used to determine whether to render graphic content.

FIG. 6 illustrates an embodiment of operations to process a context attribute rule to determine whether to render graphic content.

FIG. 7 illustrates an embodiment of operations to process a workload context rule to determine whether to render graphic content.

FIG. 8 illustrates an embodiment of operations to process a person proximity context rule to determine whether to render graphic content.

### DETAILED DESCRIPTION

When users receive messages with graphic content, such as GIF images, images with text memes, the graphic content may be rendered on a large portion of the display screen. This rendering may distract the user from current tasks and interrupt workflow or be viewed by other people nearby, which may be problematic if the graphic content is inappropriate for the environment in which it is displayed, resulting in embarrassment or other problems for the user receiving the message.

Described embodiments provide improvements to computer technology and improved data structures to filter graphic content in electronic messages received at a computing device in a messaging application so as not to render the graphic content in environments where the filter program deems such rendering to be inappropriate or undesirable. Described embodiments provide computer rules for a graphic filtering program to determine whether filtering is enabled for graphic objects and, if so, using an image classifier application to process the graphic content to determine a descriptive classifier of the graphic content. The descriptive classifier is rendered in a user interface for the message application without rendering the graphic content in response to the filtering being enabled or the graphic content in the user interface in response to determining that filtering is not enabled.

Further embodiments additionally consider wither the descriptive classifier of the graphic content comprises one of an allowed or blocked descriptive classifier and whether a context attribute value for a context attribute comprises one of an allowed context attribute value or a blocked context attribute value. Based on whether the determined descriptive classifier and context attribute value comprises an allowed or blocked descriptive classifier and context attribute, a determination is made to render the graphic content or render the determined descriptive classifier without rendering the graphic content.

Described embodiments provide a rule based system and data structures for a graphics filtering program used with a messaging application to consider various factors, such as data structures providing descriptive classifiers of graphic content and context attribute values of context attributes at the computing device at which the graphic content is considered to be rendered. Context attributes may include a current location, time, mood of user of computing device, workload of computing device, proximate persons and other factors. The rule based graphic filtering program may consider data structures providing a classification of the graphic context as well as indicating context attributes at the computing device to determine whether the graphic content should be rendered or only the determined descriptive classifier of the graphic content be rendered.

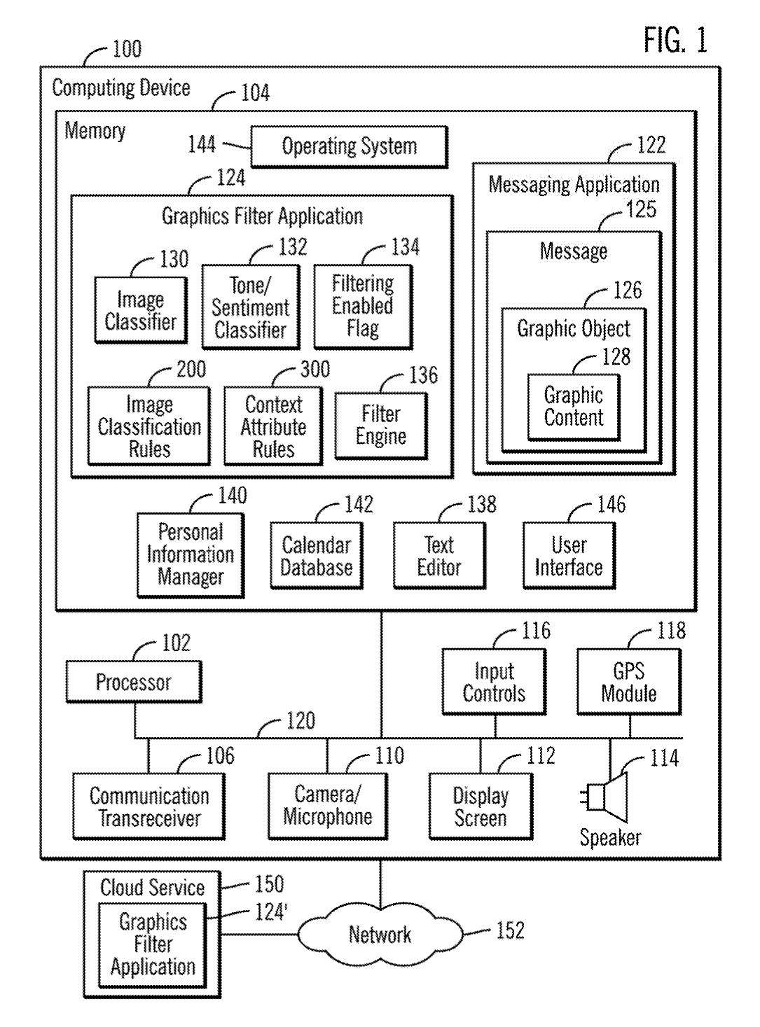

FIG. 1 illustrates an embodiment of a personal computing device 100 in which embodiments are implemented. The personal computing device 100 includes a processor 102, a main memory 104, a communication transceiver 106 to communicate (via wireless communication or a wired connection) with external devices, including a network, such as the Internet, a cellular network, etc.; a camera/microphone 110 to transmit and receive video and sound to the personal computing device 100; a display screen 112 to render display output to a user of the personal computing device 100; a speaker 114 to generate sound output to the user; input controls 116 such as buttons and other software or mechanical buttons, including a keyboard, to receive user input; and a global positioning system (GPS) module 118 to determine a GPS potions of the personal computing device. The components 102-118 may communicate over one or more bus interfaces 120.

The main memory 104 may include various program components including a messaging application 122, such as email, instant messenger program, etc., to allow the user to send and receive messages 124, which may include a graphic object 126 having graphic content 128, such as a file/object including text, video, sound and graphic images, such as in a graphic interchange format (GIF) file. A graphics filter application 124 filters graphics objects 126 included in a message 125 received at the messenger program 122. A graphics object 126 includes graphic content 128, which may comprise video, images, combination of videos or images with embedded text, GIF files, video files, etc. The graphics filter application 124 may be included in the message application 122 or an external program module. The graphics filter application 124 includes an image classifier 130 that is trained to classify the content of images; a tone/sentiment classifier 132 to classify a tone or sentiment in text; a filtering enabled flag 134 indicating whether filtering of graphic content is enabled; image classification rules 200 providing rules for processing graphics object based on the classification of the images in graphic content of the content object; context attribute rules 300 providing rules for processing graphic objects based on context attributes related to the computing device 100, such as location, time, type of computing device 100, mood of user, individuals or devices nearby, etc.; and a filter engine 136 to apply the rules 200, 300 to determine whether to render the graphic content 128 in the graphic object 126 received in a message 125 at the messaging application 122.

The computing device 100 further includes a text editor 138 in which the user of the computing device 100 may be editing text; a personal information manager 140 to manage personal information of the user of the personal computing device 100, including a calendar database 142 having stored calendar events for an electronic calendar.

The image classifier 130 may comprise an image classification program, such as, by way of example, the International Business Machines Corporation (IBM) Watson™ Visual Recognition, and the tone/sentiment classifier 132, such as by way of example, the Watson™ Tone Analyzer that can analyze tones and emotions of what people write and the Watson™ Personality Insights that can infer personality characteristics from linguistics analysis of user text. (IBM and Watson are trademarks of International Business Machines Corporation throughout the world).

The main memory 104 may further include an operating system 144 to manage the personal computing device 100 operations, interface with device components 102-120, and generate a user interface 146 in which program output is displayed.

The personal computing device 100 may comprise a smart phone, personal digital assistance (PDA), or stationary computing device, e.g., desktop computer, server, etc. The memory 104 may comprise non-volatile and/or volatile memory types, such as a Flash Memory (NAND dies of flash memory cells), a non-volatile dual in-line memory module (NVDIMM), DIMM, Static Random Access Memory (SRAM), ferroelectric random-access memory (FeTRAM), Random Access Memory (RAM) drive, Dynamic RAM (DRAM), storage-class memory (SCM), Phase Change Memory (PCM), resistive random access memory (RRAM), spin transfer torque memory (STM-RAM), conductive bridging RAM (CBRAM), nanowire-based non-volatile memory, magnetoresistive random-access memory (MRAM), and other electrically erasable programmable read only memory (EEPROM) type devices, hard disk drives, removable memory/storage devices, etc.

The bus 120 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

FIG. 1 further shows a cloud service 150, such as a cloud server, that includes the graphic filter application 124′, including the same components as described with respect to the graphic application filter 124, to perform some or all of the filtering of graphics objects 126 included in a message 125. The cloud service 150 may intercept messages 124 directed to the computing device 100 and filter before forwarding the filtered messages 124 to the computing device 100 over a network 152 to be rendered in the user interface 146. The cloud service 150 may be implemented in a network server system suitable for providing cloud services to registered users.

Generally, program modules, such as the program components 122, 124, 124′, 130, 132, 136, 138, 140, 142, 144, 146, etc., may comprise routines, programs, objects, components, logic, data structures, and so on that perform particular tasks or implement particular abstract data types. The program modules may be practiced in distributed cloud computing environments where tasks are performed by remote processing devices that are linked through a communications network. In a distributed cloud computing environment, program modules may be located in both local and remote computer system storage media including memory storage devices.

The program components and hardware devices of the personal computing device 100 of FIG. 1 may be implemented in one or more computer systems, where if they are implemented in multiple computer systems, then the computer systems may communicate over a network.

The program components 122, 124, 124′, 130, 132, 136, 138, 140, 142, 144, and 146 may be accessed by the processor 102 from the memory 104 to execute. Alternatively, some or all of the program components 122, 130, 132, 136, 138, 140, 142, 144, and 146 may be implemented in separate hardware devices, such as Application Specific Integrated Circuit (ASIC) hardware devices.

The functions described as performed by the program 122, 124, 124′, 130, 132, 136, 138, 140, 142, 144, and 146 may be implemented as program code in fewer program modules than shown or implemented as program code throughout a greater number of program modules than shown.

The network 152 may comprise one or more networks including Local Area Networks (LAN), Storage Area Networks (SAN), Wide Area Network (WAN), peer-to-peer network, wireless network, the Internet, etc.

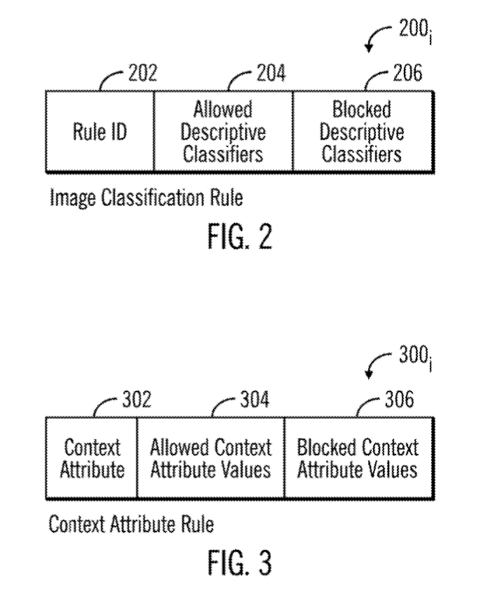

FIG. 2 illustrates an embodiment of an instance of an image classification rule 200ᵢ including a rule identifier 202, zero or more allowed descriptive classifiers 204, such that graphic content 128 classified by the image classifier 126 as having a descriptive classifier comprising one of the allowed descriptive classifiers 204 is rendered or more likely to be rendered; and zero or more blocked descriptive classifiers 206, such that graphic content 128 classified by the image classifier 130 as having a descriptive classifier comprising one of the blocked descriptive classifiers 206 is not rendered or more likely not to be rendered, and only the descriptive classifier of the graphic content 128 is rendered.

The user may set the content of the allowed 204 and blocked 206 descriptive classifiers that may be rendered or is not rendered based on user preferences.

FIG. 3 illustrates an embodiment of a context attribute rule 300ᵢ indicating a context attribute 302 related to a context of the computing device 100 in which the graphic content 128 is being considered, such as a location, time of day, type of the computing device, individuals nearby, current mood of the user, type of media of the graphic content 128, user workload at the computing device; zero or more allowed context attribute values 304 that if present at the computing device 100 indicate to render the graphic content 128 in the user interface 146; and zero or more blocked context attribute values 306 that if present indicate to not render the graphic content 128 in the graphic object 126 in the user interface 146, and instead render a description of the classified graphic content.

The user may set the content of the allowed 304 and blocked 306 context attribute values to control the context attribute values, such as location, current time, content type, user workload, user mood, etc., that determine whether the graphic content 128 should be rendered or whether just a text description of the graphic content 128 is rendered.

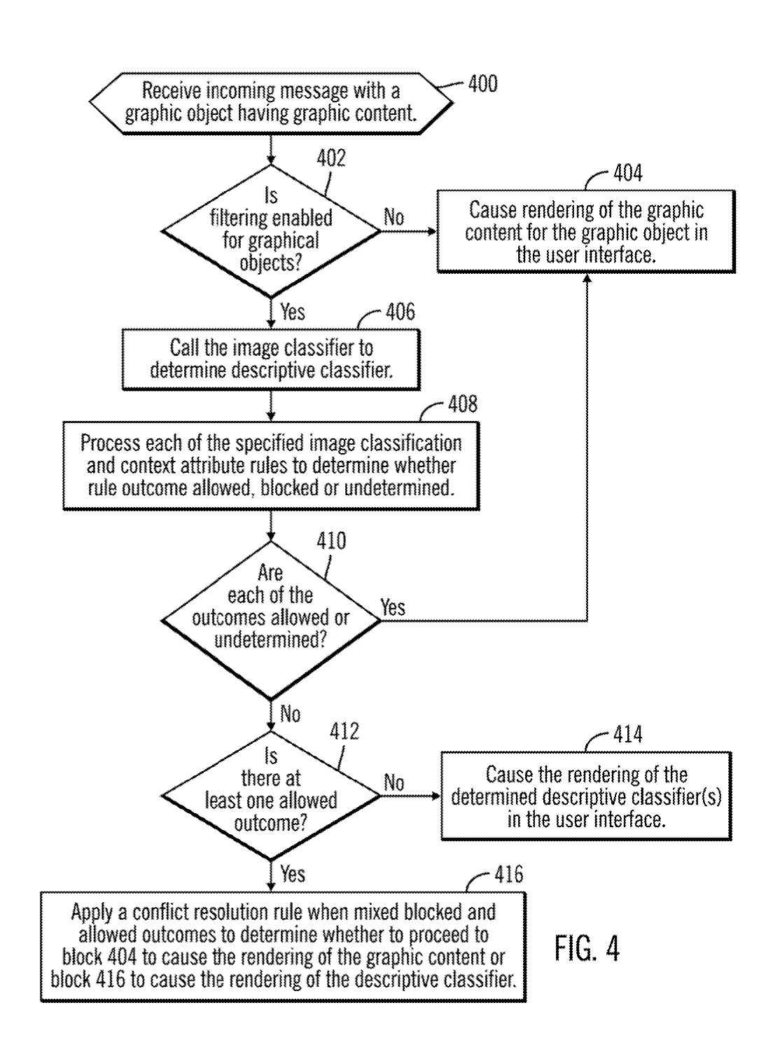

FIG. 4 illustrates an embodiment of operations performed by the filter engine 134 to apply the rules 200, 300 to determine whether to render the graphic content 128 or a textual classification of the graphic content. The filtering operations described with respect to the graphics engine 134 may be performed entirely within the computing device 100, the cloud service 150 or a combination of those devices. Upon receiving (at block 400) an incoming message 125 with a graphic object 126 having graphic content 128, if (at block 402) filtering is not enabled, as indicated in the filtering enabled flag 134, then the graphic content 128 is rendered in the user interface 146 without filtering. This may involve displaying a GIF having an image with text, such as in a meme, or a movable image. In one embodiment, when the filtering is performed in the computing device 100, then the filter engine 136 may directly cause the rendering of the graphic content 128 in the user interface 146. In an embodiment where the filtering is performed in the cloud service 150, the cloud service 150 may forward the message 125 with the graphic content 128 to cause the rendering of the graphic content 128 in the user interface 146.

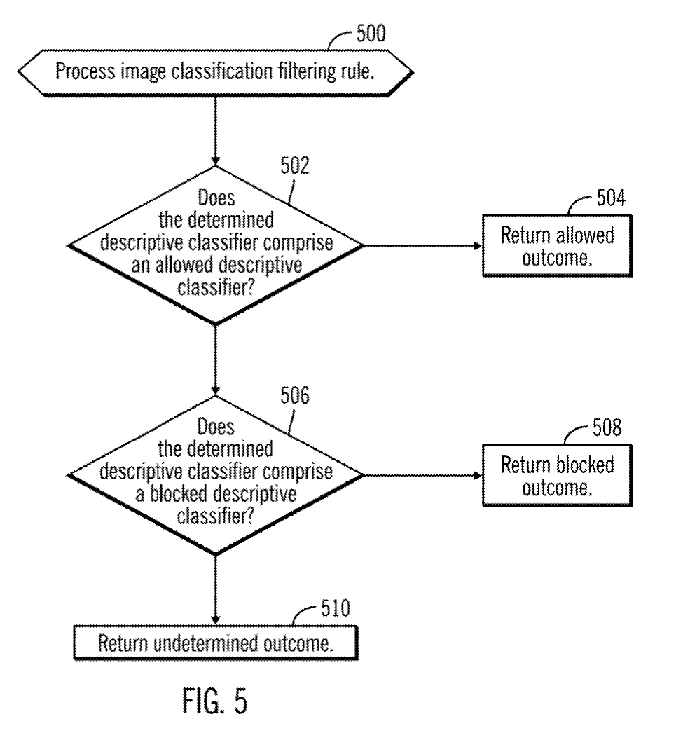

If (at block 402) filtering 134 is enabled, then the filter engine 136 calls (at block 406) the image classifier 130 to determine text comprising a descriptive classifier describing what the graphic content 128 represents, such as defining or providing a name referring to the object, things, persons, concepts and/or themes represented in the graphic content 128, including any text mentioned in the graphic content 128 that provides further meaning to the message conveyed by the graphic content 128. In certain embodiments, the image classifier 130 may include technology to recognize text in the graphic content 128 comprising an image, such as using optical character recognition (OCR) algorithms, as part of determining the descriptive classifier for the graphic content 128 including text embedded in the graphic content 128. The filter engine 136 may then process (at block 408) each of the specified image classification rules 200 and context attribute rules 300, as described with respect to FIGS. 5-8, to determine the outcomes of applying the rules, which may consider the content of the graphic content 128 or a context attribute, e.g., time, location, type of computing device 100, user mood, user workload, etc. The outcome of each of the applied rules 200, 300 may comprise allowed, blocked or undetermined. If (at block 410) each of the outcomes from the processing of the rules 200, 300 are allowed or undetermined, then control proceeds to block 404 to cause the rendering of the graphic content 128.

If (at block 410) not all the outcomes are allowed or undetermined, which means there are blocked outcomes, and if (at block 412) there is not at least one allowed outcome, which means the outcomes include only at least one blocked and undetermined outcomes, then control proceeds to block 414 to cause the rendering of the determined descriptive classifier in the user interface 146, which may comprise text describing or naming the graphic content 128. In one embodiment, when the filtering is performed in the computing device 100, then the filter engine 136 may directly cause the rendering of the determined descriptive classifier in the user interface 146. In an embodiment where the filtering is performed in the cloud service 150, the cloud service 150 may forward the message 125 with the graphic content 128 to cause the rendering at block 414 of the determined descriptive classifier in the user interface 146.

In a further embodiment, the descriptive classifier may be rendered with a hypertext link to the graphic content in the user interface 146 to allow the user to select the link to cause the rendering of the graphic content 128 in the user interface 146. In further embodiments, a confidence level indicating a confidence of the determined descriptive classifier in accurately describing the graphic content 128 may be rendered with the descriptive classifier to indicate the user the likely accuracy of the descriptive classifier in describing the graphic content 128.

If (at block 410) not all the outcomes are allowed or undetermined, which means there are blocked outcomes, and at least one outcome is allowed, meaning there are mixed blocked and allowed outcomes, then the rule engine 136 may apply (at block 416) a conflict resolution rule when there are mixed allowed and blocked outcomes to determine whether to cause the rendering of the graphic content in the user interface 146 (block 404) or cause rendering the text description of the graphic content 128 (block 414). For instance, the conflict resolution rule may favor outcomes for certain types of context attributes over other context attributes, and provide weights to the outcomes to determine which outcomes will sway the final decision of whether to render graphic content 128 or only the descriptive classifier of the graphic content 128.

The embodiment of FIG. 4 provides improved computer driven rules to determine how to process an object received by a messaging application and determine whether to cause rendering of graphic content included in a message or render a description of the graphic content based on the outcomes of applying different image classification and context attribute rules 200, 300 provided in data structures.

FIG. 5 illustrates an embodiment of operations performed by the filter engine 136 to process an image classification rule 200ᵢ. Upon processing (at block 500) an image classification rule 200ᵢ, if (at block 502) a determined descriptive classifier of the graphic content 128 comprises one of those allowed 204, then an allowed outcome is returned (at block 504). If (at block 502) the descriptive classifier is not one of the allowed descriptive classifiers 204 but comprises one of the blocked descriptive classifiers 206, then the blocked outcome is returned (at block 508). Otherwise, if the descriptive classifier of the graphic content 128 being considered is not one of the allowed 204 or blocked 206 descriptive classifiers, then an undetermined outcome is returned (at block 510).

In determining whether a determined descriptive classifier of the graphic content 128 comprises one of the allowed 204 or blocked 206 descriptive classifiers, the filter engine 136 may determine a match based on an exact match, fuzzy match or if a meaning of the determined classifier is related to a meaning of one of the allowed 204 or blocked 206 descriptive classifiers, such as by using named-entity recognition algorithms known in the art.

With the embodiment of FIG. 5, a rule driven method will process the determined descriptive classifier to determine whether based on the type of descriptive classifier, the graphic content 128 should be allowed, blocked or the outcome is undetermined.

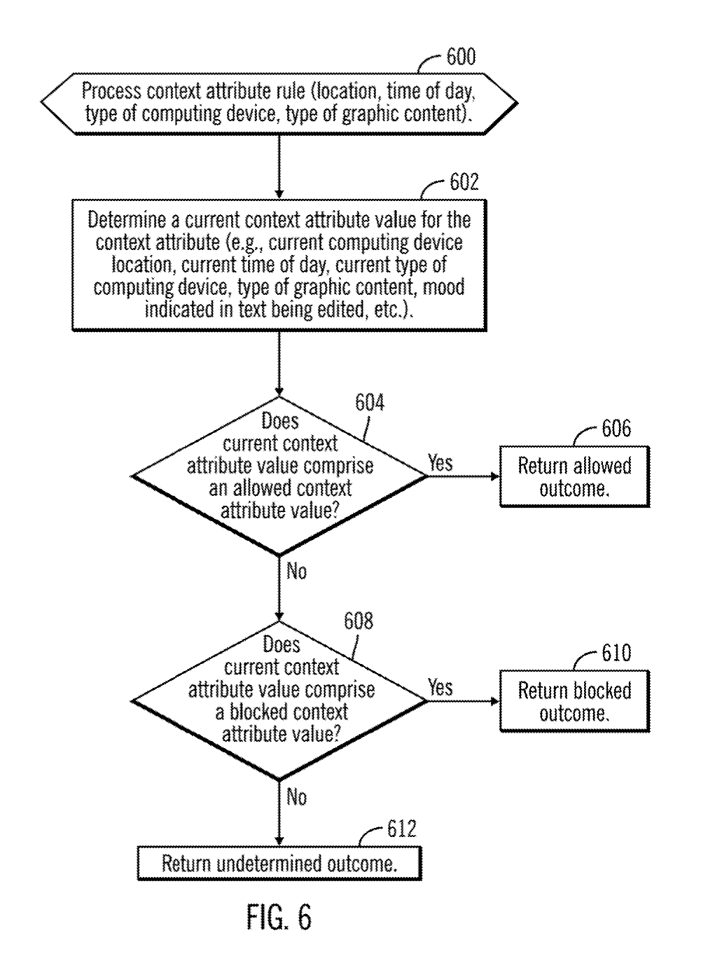

FIG. 6 illustrates an embodiment of operations performed by the filter engine 136 to process context attribute rule 300ᵢ. Upon processing (at block 600) a context attribute rule 300i, the filter engine 136 determines (at block 602) a current context attribute value for the context attribute 302. For instance, for a time context attribute, the filter engine 136 may determine a current time from a computing device 100 clock; for a location context attribute, the filter engine 136 may determine a current location from the GPS module 118, or location setting in the computing device 100; for a type of computing device context attribute, the filter engine 136 may determine the type of computing device 100 from system information for the computing device 100; for a type of graphic content 128, e.g., video, image, etc., the filter engine 136 may determine that type from file metadata of the graphic object 126; and for a mood of the user, the filter engine 136 may call the tone/sentiment classifier 132 to process text in a text editor 138 the user is currently using to determine a mood or sentiment of the text the user is entering. Additional context attributes may also be considered.

If (at block 604) the determined current context attribute value comprises an allowed context attribute 304, then an allowed outcome is returned (at block 606). If (at block 608) the current context attribute value does not comprise an allowed context attribute 304 comprises a blocked context attribute value 306, then the blocked outcome is returned (at block 610). Otherwise, if the current context attribute value is not allowed 304 or blocked 306, then an undetermined outcome is returned (at block 612).

In determining whether a determined current context attribute value comprises one of the allowed 304 or blocked 306 context attribute values, the filter engine 136 may determine a match based on an exact match, fuzzy match or if a meaning of the determined classifier is related to a meaning of one of the allowed 304 or blocked 306 context attribute values, such as by using named-entity recognition algorithms known in the art.

With the embodiment of FIG. 6, the filter engine 136 may consider certain context attributes at the computing device 100 related to a context of the computing device 100 or the user of the computing device 100, where such context attribute values may be considered in determining whether the user would prefer rendering of the graphic content 128 or a descriptive classifier of the graphic content 128.

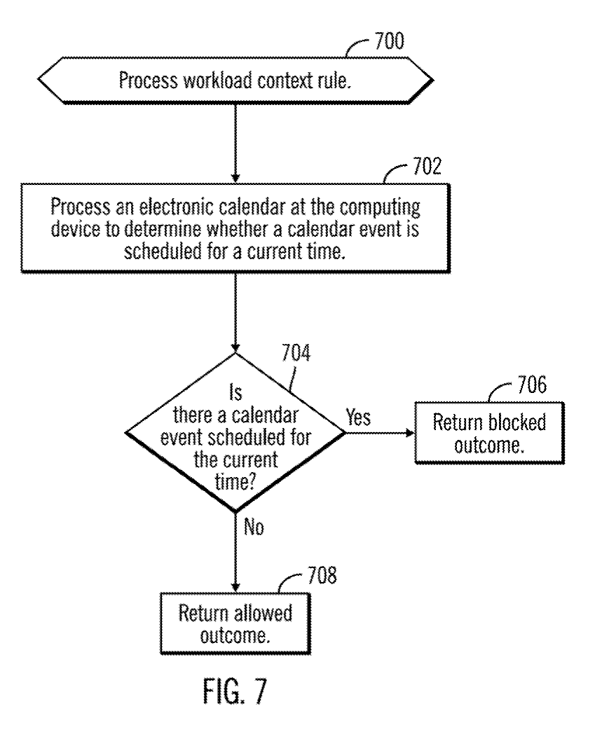

FIG. 7 illustrates an embodiment of operations performed by the filter engine 136 to process a workload context rule 300ᵢ. Upon processing (at block 700) a workload context rule, the filter engine 136 processes (at block 702) the electronic calendar 142 of the user of the computing device 100 to determine whether a calendar event is scheduled for a current time. If (at block 704) there is a calendar event for the current time, indicating the user is currently busy, then blocked outcome is returned (at block 706). Otherwise, if there is no calendar event scheduled, then an allowed outcome is returned (at block 708). Other factors may also be considered to determine whether the user workload is busy, such as the type or number of application programs the user is operating within, other programs that are open and being used that indicate the user is preoccupied and should not be interrupted, such as communication programs.

With the embodiment of FIG. 7, the context of the user current workload is used to indicate whether graphic content 128 should be suppressed at the current time because graphic content 128 is often distracting due to its visual nature.

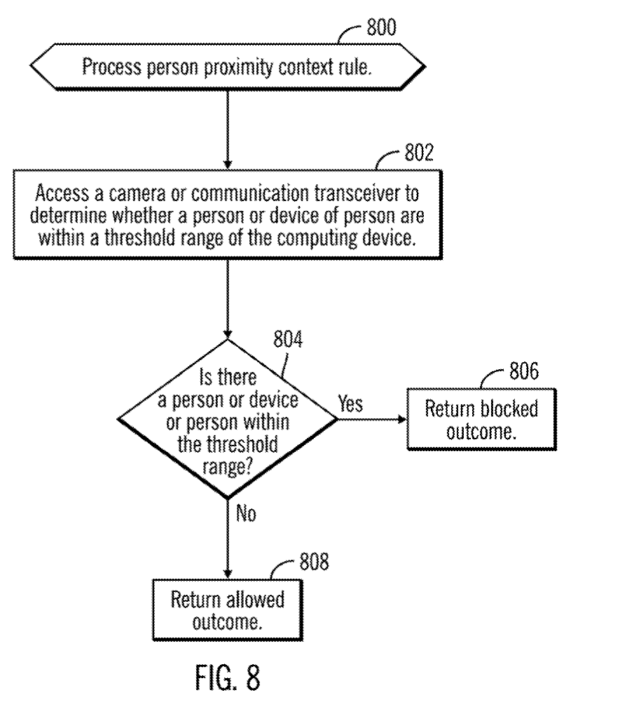

FIG. 8 illustrates an embodiment of operations performed by the filter engine 136 to process a person proximity context rule 300ᵢ. Upon processing (at block 800) a person proximity context rule, the filter engine 136 may access (at block 802) a camera 110 or communication transceiver 106 to determine whether a person or device of a person are within a threshold range of the computing device. For instance, the camera 110 may discern a person within a threshold range and the communication transceiver 106, e.g., Bluetooth or Wi-Fi device, may detect a personal computing device, such as a smartphone, within the threshold range. If (at block 804) there is a person or device currently used by a person within the threshold range, then the blocked outcome is returned (at block 806). Otherwise, if there is no person or person's device within the threshold range, then an allowed outcome is returned (at block 708).

With the embodiment of FIG. 8, the context of persons within proximity of the user's device, such as a proximity where they can observe content on the display screen 112 of the computing device 100, may be used to determine whether to suppress rendering the graphic content 128, and instead just render the descriptive classifier of the graphic content 128. In this way, the graphics filter application 124 may suppress the rendering of graphic content 128 when others are nearby to avoid having nearby people view the graphic content 128, while at the same time conveying the subject matter of the content through the descriptive text that is rendered in the user interface 146.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The letter designators, such as i and n, used to designate a number of instances of an element may indicate a variable number of instances of that element when used with the same or different elements.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A computer program product for filtering message content for a messaging application executing in a computing device, the computer program product comprising a computer readable storage medium having computer readable program code embodied therein that executes to perform operations, the operations comprising:
processing an incoming message for the messaging application including a graphic object having graphic content;
processing, by an image classifier application, the graphic content to determine a descriptive classifier of the graphic content in response to determining that filtering is enabled;
causing rendering of the descriptive classifier in a user interface without rendering the graphic content in response to the filtering being enabled; and
causing rendering of the graphic content in the user interface in response filtering not being enabled.

2. The computer program product of claim 1, wherein the processing the incoming message, the determining whether filtering is enabled, and the processing the graphic content to determine the descriptive classifier are performed in at least one of a user computing device including the user interface and a cloud server providing a cloud service to process incoming messages for multiple users at multiple computing devices in a network.

3. The computer program product of claim 1, wherein the operations further comprise:
determining whether the graphic content includes text and an image as part of processing the graphic content, wherein the rendering the descriptive classifier further comprises rendering the text in the graphic content.

4. The computer program product of claim 1, wherein the operations further comprise:
indicating at least one allowed descriptive classifier of graphic content to allow and at least one blocked descriptive classifier of graphic content to block;
determining whether the determined descriptive classifier comprises one of the at least one allowed or blocked descriptive classifier; and
causing the rendering the graphic content in the user interface for the message application in response to determining that the determined descriptive classifier comprises one of the at least one allowed descriptive classifier, wherein the determined descriptive classifier is rendered in the user interface without rendering the graphic content in response to determining that the determined descriptive classifier comprises one of the at least one blocked descriptive classifier.

5. The computer program product of claim 1, wherein the operations further comprise:
indicating at least one allowed context attribute value for at least one context attribute that when present indicates to allow the graphic content and at least one blocked context attribute value for the at least one context attribute that when present indicates to block the graphic content;
processing information from the computing device related to the at least one context attribute to determine at least one current context attribute value for the at least one context attribute;
determining whether the at least one current context attribute value comprises one of the at least one allowed context attribute value or the at least one blocked context attribute value; and
causing the rendering of the graphic content in the user interface in response to determining that the at least one current context attribute value comprises one of the at least one allowed context attribute value, wherein the descriptive classifier is rendered in the user interface without rendering the graphic content in response to determining that the at least one current context attribute value comprises one of the at least one blocked context attribute value.

6. The computer program product of claim 5, wherein the operations further comprise:
indicating at least one allowed descriptive classifier of graphic content to allow and at least one blocked descriptive classifier of graphic content to block; and
determining whether the determined descriptive classifier comprises one of the at least one allowed descriptive classifier or the at least one blocked descriptive classifier, wherein the processing the information in the computing device to determine the at least one current context attribute value and determining whether the at least one current context attribute value is allowed or blocked are performed in response to determining that the descriptive classifier comprises one of the at least one allowed descriptive classifier.

7. The computer program product of claim 5, wherein the at least one context attribute comprises at least one of a location of the computing device, a time of day, a type of the computing device, a type of content of the graphic object, a proximity of other persons to the computing device, and a current screen sharing status, wherein the at least one allowed and blocked context attribute values comprise times of day, locations for the computing device, types of the computing device, proximity of other users, a current screen sharing status, and types of content of the graphic object depending, respectively.

8. The computer program product of claim 1, wherein the operations further comprise:
processing an electronic calendar in the computing device to determine whether a calendar event is scheduled at a current time in response to the filtering being enabled; and
rendering the graphic content in the user interface in response to determining that there is no calendar event scheduled for the current time, wherein the descriptive classifier is rendered in the user interface without rendering the graphic content in response to determining the calendar event scheduled for the current time.

9. The computer program product of claim 1, wherein the operations further comprise:
determining a confidence level of the descriptive classifier, wherein the descriptive classifier is rendered with the determined confidence level in the user interface when the descriptive classifier is rendered.

10. The computer program product of claim 1, wherein the operations further comprise:
indicating at least one allowed mood of a user of the computing device that when present indicates to allow the graphic content and at least one blocked mood of the user that when present indicates to block the graphic content;
processing text content in a text editor program executing in the computing device in which the user is currently editing the text content;
analyzing the text content using a mood analyzer program to determine a mood of the user comprising at least one of a plurality moods classified by the mood analyzer program; and
causing the rendering the graphic content in the user interface in response to the determined mood of the user comprising one of the at least one allowed mood, wherein the descriptive classifier is rendered in the user interface without rendering the graphic content in response to the determined mood of the user comprising one of the at least one blocked mood.

11. The computer program product of claim 1, wherein the operations further comprise:
causing the rendering of a link in the user interface with the descriptive classifier, where user selection of the link causes access of the graphic content.

12. A system for filtering message content for a messaging application at a computing device, comprising:
a processor; and
a computer readable storage medium having computer readable program code embodied therein that when executed by the processor performs operations, the operations comprising:
processing an incoming message for the messaging application including a graphic object having graphic content;
processing, by an image classifier application, the graphic content to determine a descriptive classifier of the graphic content in response to determining that filtering is enabled;
causing rendering of the descriptive classifier in a user interface without rendering the graphic content in response to the filtering being enabled; and
causing rendering of the graphic content in the user interface in response filtering not being enabled.

13. The system of claim 12, wherein the operations further comprise:
indicating at least one allowed descriptive classifier of graphic content to allow and at least one blocked descriptive classifier of graphic content to block;
determining whether the determined descriptive classifier comprises one of the at least one allowed or blocked descriptive classifier; and
causing the rendering the graphic content in the user interface for the messaging application in response to determining that the determined descriptive classifier comprises one of the at least one allowed descriptive classifier, wherein the determined descriptive classifier is rendered in the user interface without rendering the graphic content in response to determining that the determined descriptive classifier comprises one of the at least one blocked descriptive classifier.

14. The system of claim 12, wherein the operations further comprise:
indicating at least one allowed context attribute value for at least one context attribute that when present indicates to allow the graphic content and at least one blocked context attribute value for the at least one context attribute that when present indicates to block the graphic content;
processing information from the computing device related to the at least one context attribute to determine at least one current context attribute value for the at least one context attribute;
determining whether the at least one current context attribute value comprises one of the at least one allowed context attribute value or the at least one blocked context attribute value; and
causing the rendering of the graphic content in the user interface in response to determining that the at least one current context attribute value comprises one of the at least one allowed context attribute value, wherein the descriptive classifier is rendered in the user interface without rendering the graphic content in response to determining that the at least one current context attribute value comprises one of the at least one blocked context attribute value.

15. The system of claim 12, wherein the operations further comprise:
processing an electronic calendar in the computing device to determine whether a calendar event is scheduled for at a current time in response to the filtering being enabled; and
rendering the graphic content in the user interface in response to determining that there is no calendar event scheduled for the current time, wherein the descriptive classifier is rendered in the user interface without rendering the graphic content in response to determining the calendar event scheduled for the current time.

16. The system of claim 12, wherein the operations further comprise:
indicating at least one allowed mood of a user of the computing device that when present indicates to allow the graphic content and at least one blocked mood of the user that when present indicates to block the graphic content;
processing text content in a text editor program executing in the computing device in which the user is currently editing the text content;
analyzing the text content using a mood analyzer program to determine a mood of the user comprising at least one of a plurality moods classified by the mood analyzer program; and
causing the rendering the graphic content in the user interface in response to the determined mood of the user comprising one of the at least one allowed mood, wherein the descriptive classifier is rendered in the user interface without rendering the graphic content in response to the determined mood of the user comprising one of the at least one blocked mood.

17. A computer implemented method for filtering message content for a messaging application at a computing device, comprising:
processing an incoming message for the messaging application including a graphic object having graphic content;
processing, by an image classifier application, the graphic content to determine a descriptive classifier of the graphic content in response to determining that filtering is enabled;
causing rendering of the descriptive classifier in a user interface without rendering the graphic content in response to the filtering being enabled; and
causing rendering of the graphic content in the user interface in response filtering not being enabled.

18. The method of claim 17, further comprising:
indicating at least one allowed descriptive classifier of graphic content to allow and at least one blocked descriptive classifier of graphic content to block;
determining whether the determined descriptive classifier comprises one of the at least one allowed or blocked descriptive classifier; and
causing the rendering the graphic content in the user interface for the message application in response to determining that the determined descriptive classifier comprises one of the at least one allowed descriptive classifier, wherein the determined descriptive classifier is rendered in the user interface without rendering the graphic content in response to determining that the determined descriptive classifier comprises one of the at least one blocked descriptive classifier.

19. The method of claim 17, further comprising:
indicating at least one allowed context attribute value for at least one context attribute that when present indicates to allow the graphic content and at least one blocked context attribute value for the at least one context attribute that when present indicates to block the graphic content;
processing information from the computing device related to the at least one context attribute to determine at least one current context attribute value for the at least one context attribute;
determining whether the at least one current context attribute value comprises one of the at least one allowed context attribute value or the at least one blocked context attribute value; and
causing the rendering of the graphic content in the user interface in response to determining that the at least one current context attribute value comprises one of the at least one allowed context attribute value, wherein the descriptive classifier is rendered in the user interface without rendering the graphic content in response to determining that the at least one current context attribute value comprises one of the at least one blocked context attribute value.

20. The method of claim 17, further comprising:
processing an electronic calendar in the computing device to determine whether a calendar event is scheduled at a current time in response to the filtering being enabled; and
rendering the graphic content in the user interface in response to determining that there is no calendar event scheduled for the current time, wherein the descriptive classifier is rendered in the user interface without rendering the graphic content in response to determining the calendar event scheduled for the current time.

21. The method of claim 17, further comprising:
indicating at least one allowed mood of a user of computing device that when present indicates to allow the graphic content and at least one blocked mood of the user that when present indicates to block the graphic content;
processing text content in a text editor program executing in the computing device in which the user is currently editing the text content;
analyzing the text content using a mood analyzer program to determine a mood of the user comprising at least one of a plurality moods classified by the mood analyzer program; and
causing the rendering the graphic content in the user interface in response to the determined mood of the user comprising one of the at least one allowed mood, wherein the descriptive classifier is rendered in the user interface without rendering the graphic content in response to the determined mood of the user comprising one of the at least one blocked mood.
